(19) United States
(12) Patent Application Publication
(10) Pub. No.: US 2009/0245649 A1
(43) Pub. Date: Oct. 1, 2009

(54) Method, Program and Apparatus for Detecting Object, Computer Readable Recording Medium Storing Object Detection Program, and Printing Apparatus

(75) Inventor: Tsubasa NAKATSUKA, Kagoshima-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/409,064

(22) Filed: Mar. 23, 2009

(30) Foreign Application Priority Data
Mar. 25, 2008 (JP) 2008-079355

(51) Int. Cl. G06K 9/46; G06F 15/80; G06K 15/02

(52) U.S. Cl. 382/195; 345/505; 358/1.18; 382/298

(57) ABSTRACT

An object detection method for detecting a predetermined object image from a target image. A target image is contracted to generate a contracted image, and partitioned to generate a partitioned image. The predetermined object image is detected from the image using the image and a detection frame. The detection frame and the contracted image are used to detect the predetermined object image if the detection frame is equal to or larger than a predetermined size, and the detection frame and the partitioned image are used to detect the predetermined object image if the detection frame is smaller than the predetermined size.

### CROSS-REFERENCE TO RELATED APPLICATIONS

This application claims the benefit of priority under 35 USC 119 of Japanese application no. 2008-079355, filed on Mar. 25, 2008, which is incorporated herein by reference.

### BACKGROUND

1. Technical Field

The present invention relates to detection of a predetermined object contained in a target image.

2. Related Art

Digital images are increasingly printed at home as digital cameras are in widespread use and printing quality of home printers improves. Digital images printed at home are typically digital photographs captured by digital cameras. The digital photographs are data optically captured. If the digital photograph is printed as is, many users may be under the impression that the digital photograph is different from the image actually viewed by themselves. Prior to printing, the photograph data is thus image quality adjusted into image data that provides print results intended by the user. Image quality adjustment may be performed on the image data when the images are displayed in not only the printer, but also in an apparatus displaying a digital image, such as a digital camera or a photoviewer. The image data may thus be converted so that the display results look more natural to the user.

In order to appropriately convert the image data, the digital image is analyzed, the types of digital images (such as person, scenery, document, etc.) are determined, and the types and positions of objects (person's face, mountains, sea, buildings, vehicles, etc.) are determined. JP-A-2007-48108, for example, discloses a process of detecting a human face as an object.

Direct printers are currently increasingly used. A direct printer directly acquires image data from a memory card, a universal serial bus (USB) memory, or the like, rather than via a computer, and then prints the acquired image data. In the case of a printer receiving an image input via a computer, the computer simply supplies adjusted image data. However, a direct printer selects an appropriate image adjustment by internally performing an image type determination process or an object position identification process. In order to perform these processes, the image data needs to be expanded on a work area of a random-access memory (RAM) or the like. Because of price reduction pressure in the marketplace of home printers, an increase in the work area size is difficult to implement.

Moreover, the size of the data to be read onto the work area becomes larger and larger as the digital camera has a higher image capturing resolution and as the digital content thus becomes higher in resolution. Thus, even with the work area size subject to limitation, the size of the image data to be read onto the work area increases. The same is true of the digital camera and the photoviewer, each handing digital photographs.

### SUMMARY

The invention provides an object detection method and apparatus that executes an appropriate image evaluation on digital image data even with an insufficient work area size available for expanding the digital image data.

In accordance with one aspect of the present invention, an object detection method for detecting a predetermined object image from a target image includes an image contraction operation, an image partition operation, and a detection operation.

In the detection operation, the predetermined object image is detected from an image using the image and a detection frame. The image is one of a contracted image and a partitioned image. Which of the contracted image and the partitioned image is to be used is determined depending on the size of the detection frame. If the detection frame is equal to or larger than a predetermined size, the detection frame and the contracted image are used to detect the predetermined object image in the detection operation. If the detection frame is smaller than the predetermined size, the detection frame and the partitioned image are used to detect the predetermined object image in the detection operation. The detection frame serves as a predetermined detection area set up on the target image. The contracted and partitioned images are generated, respectively, in the image contraction and image partition operations, based on the target image serving as a detection target of the object detection method.

In the detection operation, an attempt to detect the predetermined object image from the image contained in the set detection area is performed. More specifically, if the contracted image is to be used in the detection operation, the target image is contracted to generate the contracted image in the image contraction operation. If the partitioned image is to be used the detection operation, the target image is partitioned to generated the partitioned image in the image partition operation. When the detection frame is set up on the contracted image, the detection frame is contracted at the contraction rate of the contracted image and then set up.

The predetermined object image includes an image feature (such as a face, a part of the face, and markings) contained in the target image. The detection frame may be a single closed outline or may include a plurality of outlines arranged in a predetermined geometry. A target image within an area defined by the detection frame is contracted at the contraction rate of the image contraction operation. In such a case, the predetermined size is determined as to whether the target image satisfies the degree of fineness required to detect the predetermined object image. The degree of fineness refers to how fine a detailed portion of the target image is drawn. For example, in the case of the image data, the degree of fineness is resolution. Even if the area of the image contained in the detection frame is wide with the image not finely drawn, the predetermined object image can be detected. In such a case, the contracted image is used. In contrast, the predetermined object image cannot be detected if the area of the image contained in the detection frame is narrow with the image not finely drawn. In such a case, the partitioned image is used.

In accordance with one aspect of the invention, at least one of the images partitioned from a target image in the image partition operation may contain a predetermined area at an approximate center of the target image.

A main object is typically arranged at the approximate center of the image if the image is artificially produced by humans. For example, a person photograph is typically taken with the face of the person arranged at the approximate center of the image. The partitioned image is generated so that a predetermined area at the approximate center is not partitioned. The object to be detected is thus prevented from being partitioned, and object detection failure is thus controlled.

The image partitioned from a target image in the image partition operation may have a portion overlapping an image partitioned from an adjacent part of the target image. When an image is partitioned, an object may be present along a partitioning line. An object partitioned into different images is difficult to detect. By allowing the images partitioned from the adjacent parts to have mutually overlapping portions, object detection failure along the partitioning line is prevented from taking place.

In accordance with another aspect of the invention, the overlapping portion may have a width approximately equal to a predetermined size of the detection frame.

With this arrangement, even if an object falling within the detection frame is partially out of one partitioned image, the remaining portion of the object may be definitely contained within another adjacent partitioned image. If the overlapping portion is large, there is almost no difference in size between the target image and the partitioned image, and the partitioning is not taken advantage of. In accordance with embodiments of the invention, the contracted and partitioned images are used together, and the detection frame set on the partitioned image is smaller than the predetermined size. More specifically, if the detection frame generally covering the entire image is used, the contracted image data is used, eliminating the need for the setting of the overlapping portion. If the overlapping portion becomes smaller with a smaller detection frame, the partitioned image data is used. Object detection is thus reliably performed with the overlapping portion set while each partitioned image is prevented from becoming too large.

The image used in detecting the predetermined object image may be represented by image data stored on a storage medium that stores data of a predetermined size or smaller size, and each of the contracted image and the partitioned image may be generated as data having the predetermined size or smaller size and then stored on the storage medium. The contracted image data is used in a coarse analysis process for high speed, and the partitioned image data is used in a detailed analysis process for high accuracy. An apparatus even with a small work area can thus analyze the image data.

A storage medium is available for storing the image data temporarily. An upper limit (predetermined size) is set on the storage medium. The image data of the contracted and partitioned images is contracted or partitioned into an amount of data not exceeding the upper limit of the capacity of the storage medium. The partitioned images may be different in size as long as the size of the partitioned images is not above the upper limit. Within the upper limit, the number of partitions may be appropriately selected. The storage medium may be integrated with a recording device that stores a program for detecting the object and a variety of variables in the execution of the program. In such a case, a work area available for temporarily storing the image data corresponds to the storage medium. When the object is actually detected from the image data, values of variables (such as illuminance, chroma saturation, hue, etc.) of the image data, values of image feature quantities (contrast, gradient, standard deviation, etc.) calculated from the variables of the image data, distributions of the variables and the feature quantities, are used as image features.

In accordance with another aspect of the invention, the operations of the object detection method are performed by a multi-core processor that performs parallel processing, and the multi-core processor analyzes in the detecting of the predetermined object image the data of the contracted and partitioned images in parallel processing.

The contracted image data and the partitioned image data is used in accordance with one embodiment of the invention. If the contracted and partitioned image data is expanded onto the storage medium at the same time, the used memory size is small. Parallel processing is thus easy, and high throughput is achieved. If the contracted image data and the partitioned image data is expanded onto the storage medium at the same time, a total size of the contracted image data and the partitioned image data is set to be equal to an amount of data recordable by the storage medium.

The object detection method described above may be embodied as an object detection apparatus that includes means for performing the operations of the object detection method. The invention may also embodied as an object detection system containing the object detection apparatus, a program for causing a computer to perform the operations of the object detection method, a computer readable recording medium storing the program, etc. The object detection system, apparatus, program and recording medium storing the program also provide the above-described advantages.

### BRIEF DESCRIPTION OF THE DRAWINGS

The invention will be described with reference to the accompanying drawings, wherein like numbers reference like elements.

FIG. 1 is a hardware block diagram of a printer in accordance with one embodiment of the invention.

FIG. 2 is a software block diagram of the printer.

FIG. 3 is a flowchart of an image processing process.

FIG. 4 is a flowchart of a contracted image analysis process.

FIGS. 5A and 5B illustrate a size of a size counter detection window.

FIG. 6 illustrates image switching timing.

FIG. 7 illustrates calculation of a feature quantity from window image data.

FIG. 8 diagrammatically illustrates the learning of a neural network NN.

FIG. 9 is a flowchart of a partitioned image analysis process.

FIG. 10 illustrates partitioned images.

FIG. 11 illustrates partitioned images.

FIG. 12 is a flowchart of a skin complexion adjustment process.

FIG. 13 diagrammatically illustrates a face determination process.

FIG. 14 illustrates determination characteristics in the determination method in accordance with a modified embodiment.

FIG. 15 illustrates a method of partitioning in a modified embodiment.

### DESCRIPTION OF EXEMPLARY EMBODIMENTS

### Structure of Image Processing Apparatus

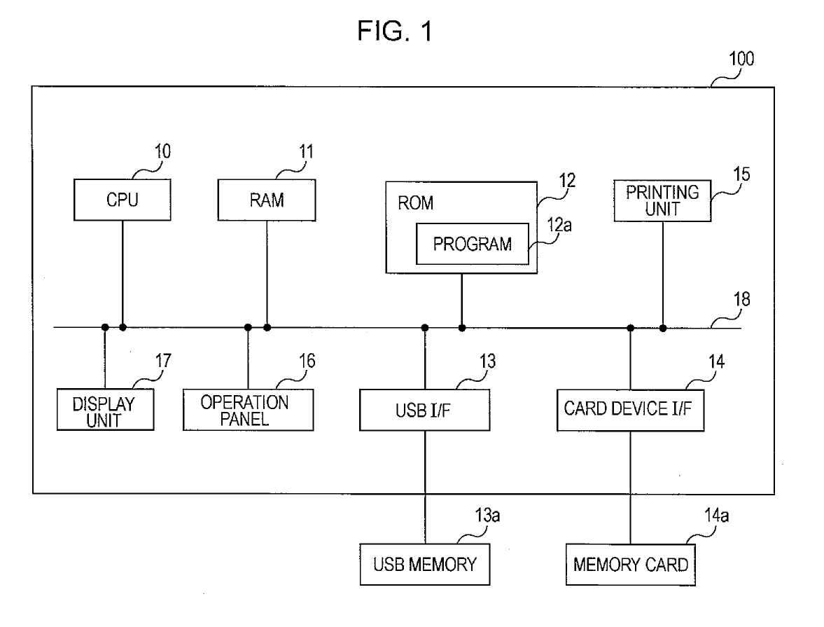

FIG. 1 illustrates a printer 100 that is an example of an object detection apparatus of one embodiment of the invention. Referring to FIG. 1, the printer 100 includes a central processing unit (CPU) 10, a random-access memory (RAM) 11, a read-only memory (ROM) 12, a graphic interface format (GIF) interface 13, a memory card interface (MIF) 14, a printing unit 15, an operation panel 16, a display unit 17, and a bus 18. The bus 18 interconnects the elements 10-17 forming the printer 100 for communication. Communication between the elements is controlled by a chip set (not shown). The ROM 12 stores program data 12a for executing a variety of programs including firmware. The CPU 10 generally controls the printer 100 by expanding the program data 12a onto the RAM 11 (a computer-readable storage medium storing data of a predetermined size or smaller size) as necessary and by performing calculations in accordance with the program data 12a.

The GIF 13 is an interface supporting the USB standard, and is connected to one of an external computer and the USB memory 13a (semiconductor memory). The MIF 14 is connected to a slot that receives the memory card 14a. The CPU 10 accesses the memory card 14a via the MIF 14, thereby reading and writing files. The operation panel 16, including a plurality of buttons, is arranged on the casing of the printer 100. The CPU 10 receives a signal responsive to an input operation on the operation panel 16. The display unit 17 displays a variety of information, images, etc. thereon in response to input data. The CPU 10 inputs to the display unit 17 data indicating content to be displayed on the display unit 17. As a result, the display unit 17 displays a variety of information, images, etc.

The printing unit 15 includes cartridges filled with cyan, magenta, yellow, and black (CMYK) inks, print heads ejecting the inks in the cartridges toward a recording surface of a recording medium, application specific integrated circuits (ASICs) controlling an amount of ejected ink from the print head, and a control IC controlling a carriage mechanism having the print heads and the ink cartridges thereon, and controlling a transport speed of the recording medium. The printing unit 15 under the control of the CPU 10 prints predetermined image data on the recording medium.

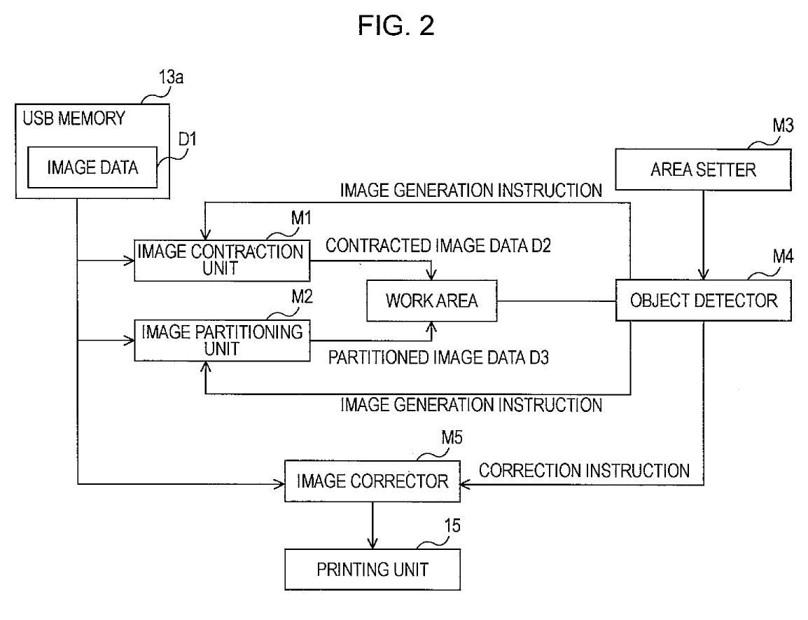

FIG. 2 is a software block diagram of a program executed by the printer 100. Referring to FIG. 2, the printer 100 executes firmware and an image processing module M. The image processing module M includes an image contraction unit M1, an image partitioning unit M2, an area setter M3, an object detector M4, and an image corrector M5. Via the firmware, the image processing module M acquires the image data from one of the memory card 14a and the USB memory 13a, and issues to the printing unit 15 an instruction to print the image data. The printer 100 may be a multi-purpose apparatus having multi-functions including copy and scanner functions. Processes of the units M1-M5 forming the image processing module M are described in detail below.

### Flow of Image Processing Process

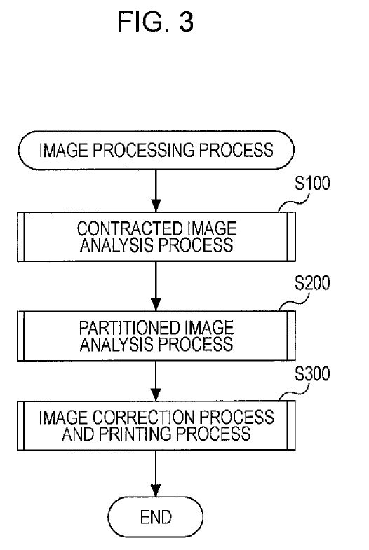

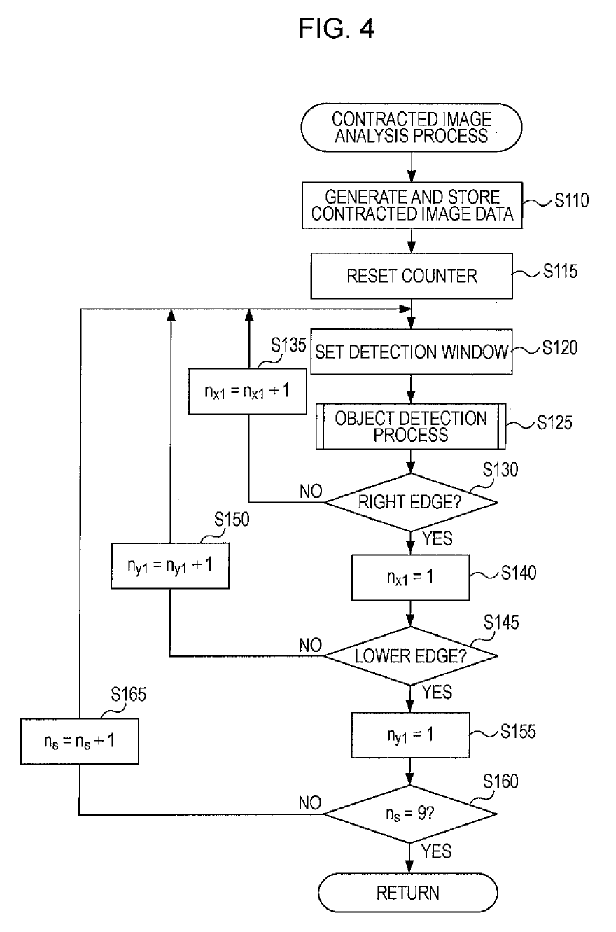

FIG. 3 is a flowchart of an image processing process. FIG. 4 is a flowchart of a contracted image analysis process. The contracted image analysis process and the partitioned image analysis process of FIG. 3 correspond to an object detection process of one embodiment of the invention. When the image processing process is initiated, the contracted image analysis process (step S100) of FIG. 3 starts. In step S110 (hereinafter each step number is simply referred to as S110 without using the word step) in FIG. 4, the image contraction unit M1 acquires image data D1 (n×m pixels) of an image as a target of the image processing process (target image), contracts the image data D1 into contracted image data D2 ((n/z)×(m/z) pixels) by a predetermined contraction ratio of (1/z(z>1)), and stores the contracted image data D2 onto a work area of the RAM 11.

The image data D1 can be retrieved from a predetermined recording medium such as the memory card 14a or the USB memory 13a. If the printer 100 includes a hard disk drive (HDD) the image contraction unit M1 can receive the image data D1 from the HDD. The image contraction unit M1 can also retrieve the image data D1 from a PC, a server, or a digital camera via the GIF 13. The image data D1 may be specified as a target image by the user who operates the operation panel 16 while viewing a user interface (UI) displayed on the display unit 17.

The image data D1 is bitmap data composed of a plurality of pixels. Each pixel is represented by a combination of gradations of red (R), green (G) and blue (B) channels (for example, 256 gradations of 0-255). The image data D1 in a recorded state on a recording medium or the like may be compressed in accordance with a predetermined compression method such as JPEG. Alternatively, the color of each pixel may be represented in another color space. If the image data D1 is not RGB bitmap data, the image contraction unit M1 expands the image data D1 and converts color space of the image data D1, and then acquires the image data D1 as RGB bitmap data.

The contracted image data D2 is bitmap data that is contracted in image size, for example, by reducing the number of pixels of the acquired image data D1. The size contraction is performed by decimating the number of pixels, or by forming a new one pixel through interpolation calculation on a predetermined number of pixels. The contracted image data D2, having a size that can be stored on the work area of the RAM 11, is stored on the work area. The work area is a storage area of the RAM 11 that is available to temporarily store image data related to the object detection process, and excludes a storage area needed to execute a control program of the printer 100. If the image data D1 with the size thereof unchanged is stored on the work area, the image data D1 may be used in the object detection to be described later, without producing the contracted image data D2 and partitioned image data D3 to be discussed later.

If image information required for the object detection process is luminance information only, the contracted image data D2 may be constructed of bitmap data of gray scale. Given the same number of pixels, a gray scale image needs a smaller amount of data than a color image. The amount of data to be processed is reduced. The speed of the object detection process is thus increased and a modest contraction rate of the contracted image data still works. Gray scale image conversion may be performed on the image data D1 or the contracted image data D2. If the image on the image data D1 is gray scale converted, the amount of calculation involved in the contraction process is reduced.

In S115-S165, the area setter M3 sets a detection window W1 (detection outline) of each size within the contracted image and acquires window image data WD, and detects an object. The detection window W1 is a virtual outline defining a portion of the contracted image. The object detector M4 acquires as the window image data WD the data of the contracted image within the area specified by the detection window W1, and then performs the object detection process to be discussed later. The detection window W1 may have a circular shape, a rectangular shaper a triangular shape, or any other shape. The detection window W1 is not limited to a single closed area and may be a combination of a plurality of closed areas.

In S115, counters nₛ, nₓ₁, and n_{y1} are reset. Here, nₛ is a size counter, and provides an integer for shifting successively a size parameter S1 of the detection window W1 and a size parameter S0 of a detection window W0. The counter nₓ₁ as an x direction counter provides an integer for shifting a center position P1 of the detection window W1 in the x axis direction. The counter n_{y1} as a y direction counter provides an integer for shifting a center position P1 of the detection window W1 in the y axis direction. These counters are initialized to 1, for example, at the resetting thereof. In accordance with the present embodiment, the longitudinal direction of the contracted image data D2 is the x axis, and the short-side direction of the contracted image data D2 is the y axis, and the origin of the x axis and the y axis is at the upper left corner of working image data.

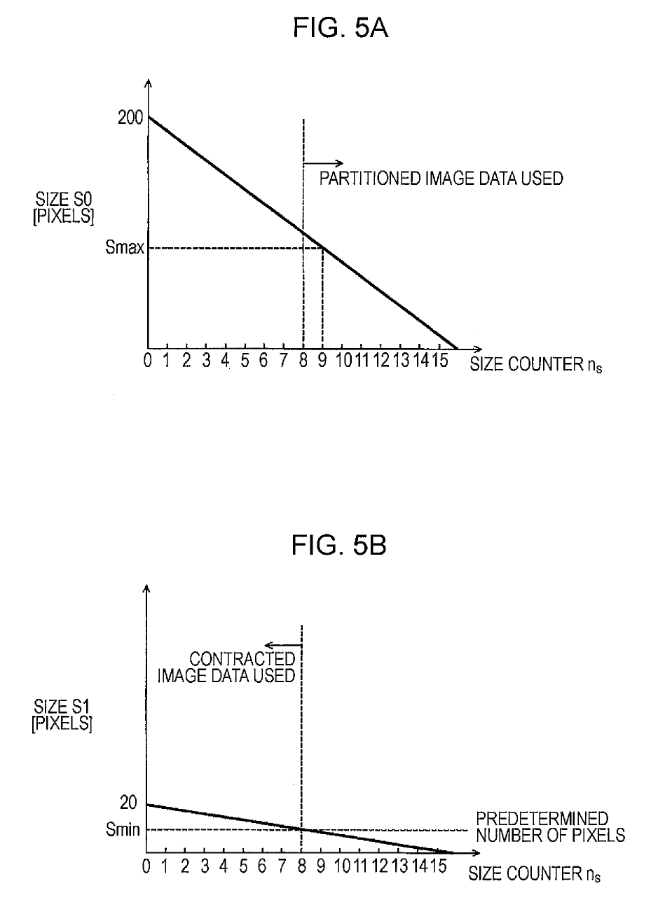

FIGS. 5A and 5B illustrate a relationship between the counter nₛ and the size parameter S1 of the detection window W1 and a relationship between the counter nₛ and the size parameter S0 of the detection window W0. As illustrated in FIGS. 5A and 5B, the size S1 (the vertical and horizontal length) of the detection window W1 decreases as the count of the counter nₛ increases. Similarly, the size parameter S0 (the vertical and horizontal length) of the detection window W0 gradually decreases as the count of the counter nₛ increases. In accordance with the present embodiment, the counter nₛ is linearly related to the size S1 and the size S0. Each time the counter nₛ increments by one within a range of 1-15, the size S1 (the vertical and horizontal length) of the detection window W1 decrements by 12/z pixels, and the size S0 (the vertical and horizontal length) of the detection window W0 decrements by 12 pixels. When the count of the counter nₛ is 1, the maximum size S1 has 200/z pixels slightly shorter than the short side of the detection window W1 and the maximum size S0 has 200 pixels slightly shorter than the short side of the detection window W0. When the count of the counter nₛ is 15, the size S1 of the detection window W1 is 20/z pixels and the size S0 of the detection window W0 is 20 pixels. The relationship between the counter nₛ and the size S1 of the detection window W1 and the relationship between the counter nₛ and the size S0 of the detection window W0 are examples only. Alternatively, the gradients and the intercepts may be modified, or these relationship may be non-linear.

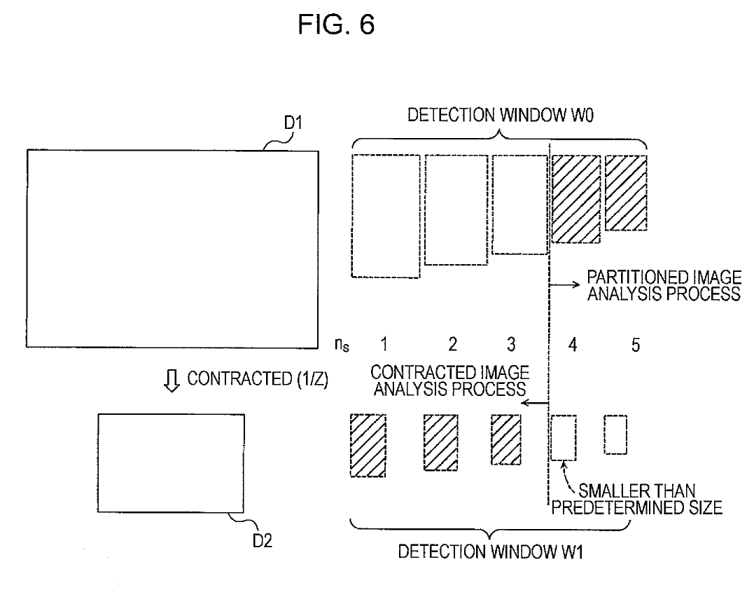

FIG. 6 illustrates a timing at which the target image is switched from the contracted image to the partitioned image. When the number of pixels contained in the window image data WD is below a predetermined number of pixels (for example, 4×4 pixels), an image feature quantity cannot be extracted in the object detection process. More specifically, if the window image data WD is lower than a predetermined number of pixels, the object detection process on the target image is aborted. Since the contracted image is lower in resolution than the partitioned image, the window image data WD acquired from the contracted image reaches the predetermined number of pixels earlier than that from the partitioned image. For this reason, the target image is switched to the partitioned image when the number of pixels of the window image data WD becomes lower than the predetermined number of pixels.

Referring to FIG. 5, a relationship of S1=S0/z holds between the size S0 of the detection window W0 set in the partitioned image data D3 and the size S1 of the detection window W1 set in the contracted image data D2. More specifically, a minimum size Sₘᵢₙ of the detection window W1 and a maximum size S₀ₘₐₓ of the detection window W0 applied to the partitioned image data D3 satisfy the following relationship:

S₀ₘₐₓ≈Sₘᵢₙ×z and S₀ₘₐₓ>Sₘᵢₙ×z

In S105, the area setter M3 sets the detection window W1 having the size S centered on the center position P1 on the contracted image.

In S110, the object detector M4 acquires and analyzes the window image data WD (the image data within the detection window W1) and detects a face image (a predetermined object) in accordance with the image feature quantity of the window image data WD. The image feature quantities are obtained by applying a variety of filters on the window image data WD and calculating feature quantities (an average, a maximum value, a minimum value, a standard deviation, etc.) indicating states of luminance, an edge and contrast within each filter. The window image data WD is different depending on the size of the detection window W1. In analysis, the window image data WD is resolution converted beforehand to a constant size.

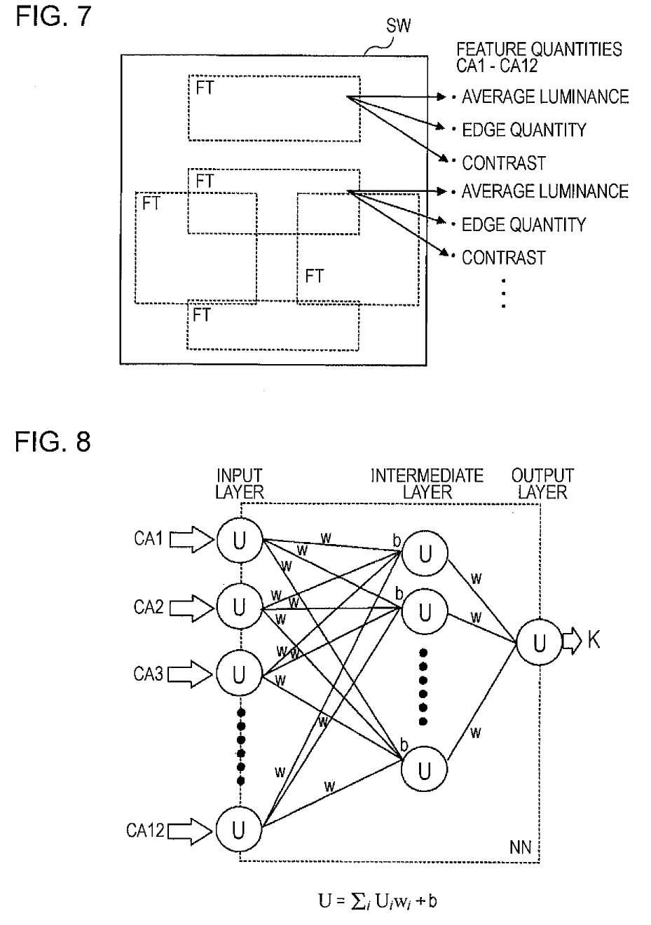

FIG. 7 illustrates calculation of the feature quantity from the window image data WD. Referring to FIG. 7, many filters FT are prepared for the window image data WD. The filters FT are successively applied to the window image data WD. For example, 12 feature quantities CA1-CA12 are calculated in the image within each filter FT. When the feature quantities CA1-CA12 are calculated, the object detector M4 inputs the feature quantities CA1-CA12 to a pre-arranged neural network NN. The neural network NN outputs determination results indicating whether a face image or the like is present or not. If the determination results indicate that a face image is detected in the image feature quantity, the object detector M4 stores a detection position of the face image on the RAM 11.

FIG. 8 diagrammatically illustrates the learning of the neural network NN. The neural network NN has a basic structure in which the linear coupling of values of units U at a front layer determines the value of each unit U at a back layer. To support non-linear characteristics of an input-output relationship, a value resulting from the linear coupling is preferably converted using a non-linear function such as a hyperbolic tangent function and a value of a unit U at a next layer is thus determined. In accordance with the present embodiment, the number of units U, and the magnitudes of weights W and biases b in the linear coupling between the units U are thus optimized through the learning process using the error back propagation technique. In the learning process using the error back propagation technique, the magnitude of the weight w and the value of the bias b in the linear coupling between the units U are set to initial values.

The feature quantities CA1-CA12 of known learning image data are determined in the same manner as in S125 as to whether a face image is present, and are then input to the initially set neural network NN. An output value K is then obtained from the neural network NN. The learning image data prepared needs to be as large as possible. In order to detect face images in a variety of states, the learning image data needs to be large enough to cover many persons in terms of race, sex and a wide range of ages. Face images contained in the image data captured by digital still cameras or the like may look in a variety of directions. For this reason, learning image data containing face images looking in a variety of directions is prepared. Since humans typically are photographed with the faces oriented rightward or leftward rather than tilted downward or upward, a large number of units of learning image data captured with the faces looking rightward or leftward are prepared.

The neural network NN preferably outputs 1 as the output value K responsive to learning image data containing a face image, and preferably outputs 0 as the output value K responsive to learning image data containing no face image. The magnitude of the weight W and the value of the bias b in the linear coupling of the units U are merely set to the initial values thereof, and an error takes place between the actual output value K and an ideal value. The weight W and the bias B of each unit U minimizing such an error are also calculated using a numerical optimization technique such as a gradient method. The error is propagated from the back layer to the front layer, and the weight W and the bias b of the unit U at the back layer is optimized. When the neural network NN thus optimized is used, an output value K close to 1 is output for the feature quantities CA1-CA12 if a face image is contained in the window image data WD. An output value K close to 0 is output for the feature quantities CA1-CA12 if a face image is not contained in the window image data WD. A threshold determination process using a threshold value of 0.5 is performed in order to determine whether a face image is present in the window image data WD.

If it is determined that a face image is present in the window image data WD, the object detector M4 causes the RAM11 to store the size S1, position P0, and angle of rotation T of the detection window W1 from which the window image data WD is obtained. Processing then returns. On the other hand, if it is determined that no face image is present in the window image data WD, processing immediately returns.

In S130-S165, the detection window W1 is placed within the entire contracted image with the size of the detection window W1 successively changed. The placement position of the detection window W1 is determined from the following equation (1):

$${P}_{1} ( x , y ) = ( {d}_{x 1} {n}_{x 1} , {d}_{y 1} {n}_{y 1} ) \\ {d}_{x 1} = \frac{0.20}{z} \times {S}_{1} \\ {d}_{y 1} = \frac{0.04}{z} \times {S}_{1} \qquad ( 1 )$$

where P1(x,y) represents a center position of the detection window W1, and dₓ₁ and d_{y1} represent a movement length representing unit travel distance (the number of pixels) of the center position P1 of the detection window W1 to each direction. By multiplying the movement length dₓ₁ and d_{y1} by the counts of the direction counters nₓ₁ and n_{y1} respectively, x and y coordinates of the center position P1 of the detection window W1 are calculated. Since the center position P1 calculated in equation (1) is set up anywhere in the target image depending on the size of the detection window W1, the detection window W1 is set up covering the entire target image. If the movement length d_{y1}<1, d_{y1}=1. The x direction counter nₓ₁ takes an integer falling within a range of 1 to (the number of pixels of the contracted image data in the x direction)/dₓ₁, and the y direction counter n_{y1} takes an integer falling within a range of 1 to (the number of pixels of the contracted image data in the y direction)/d_{y1}. More specifically, the larger the detection window W1, the longer the unit travel distance of the detection window W1, and the smaller the detection window W1, the shorter the unit travel distance.

In S130, it is determined whether the detection window W1 has reached the right edge in the x axis direction. If the detection window W1 has not reached the right edge in the x axis direction, the x direction counter is incremented by 1 in S135 to shift the detection window W1 in the x axis direction by the unit travel distance dₓ₁. If the detection window W1 has reached the right edge in the x axis direction, the x direction counter by nₓ₁ is reset to 1 in S140 to return the detection window W1 back to the left edge, and processing proceeds to S145.

In S145, it is determined whether the detection window W1 has reached the lower edge in the y axis direction. If the detection window W1 has not reached the lower edge in the y axis direction, the y direction counter n_{y1} is incremented in S150 to shift the detection window W1 in the y axis direction by the unit travel distance d_{y1}. If the detection window W1 has reached the lower edge, the y direction counter n_{y1} is reset to 1 in S155 to return the detection window W1 to the upper edge, and processing proceeds to S160.

In S160, it is determined whether the detection window W1 has reached the predetermined size. If the detection window W1 has reached the predetermined size (nₛ=9 in FIG. 4), the contracted image analysis process is terminated and processing returns. If the detection window W1 has not reached the predetermined size, the counter nₛ is incremented in S165 to contract the size S1 of the detection window W1 by unit quantity and processing returns to S120.

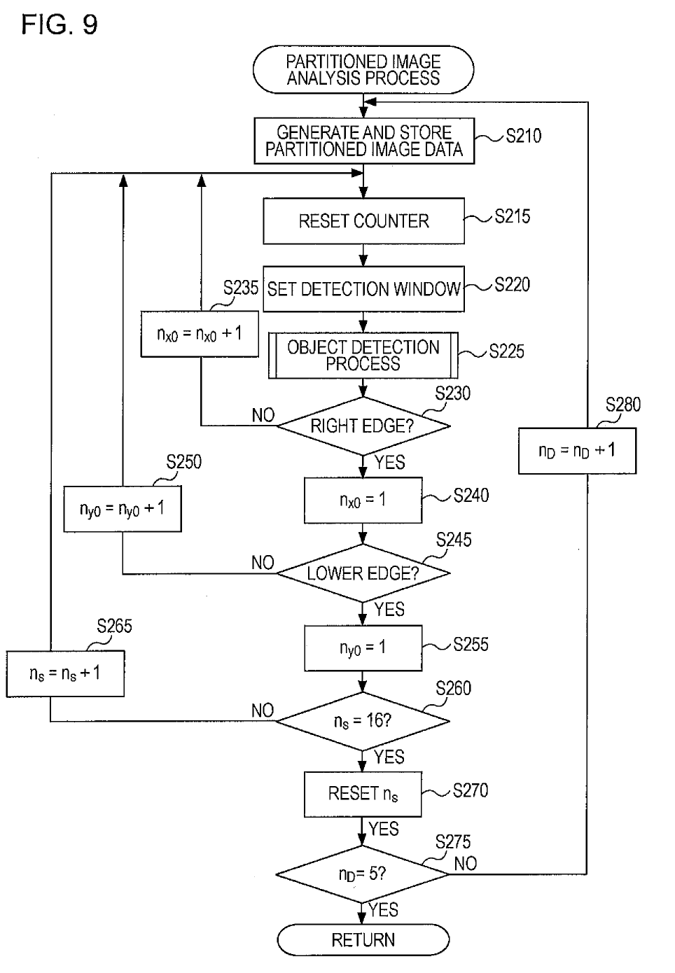

FIG. 9 is a flowchart of the partitioned image analysis process in S200 in FIG. 3.

In S210, the image partitioning unit M2 generates the partitioned image data of one of the images partitioned from the target image of the image data D1. In accordance with the present embodiment, the image data D1 is partitioned into four. Some of partitioned image data D3-D6 is generated. The partitioned image data D3 is smaller than a size that can be stored on the work area of the RAM 11. The generated partitioned image data D3 is stored on the work area. As with the previously discussed contracted image data D2, the partitioned image data D3 may be bitmap data of gray scale if information for the object detection process is luminance information only. Gray scale conversion may be performed on the image data D1 or the partitioned image data D3 subsequent to the partitioning.

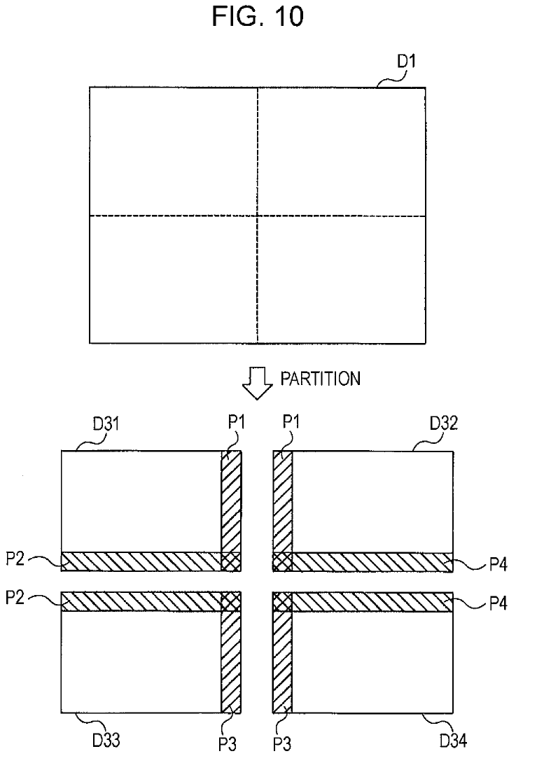

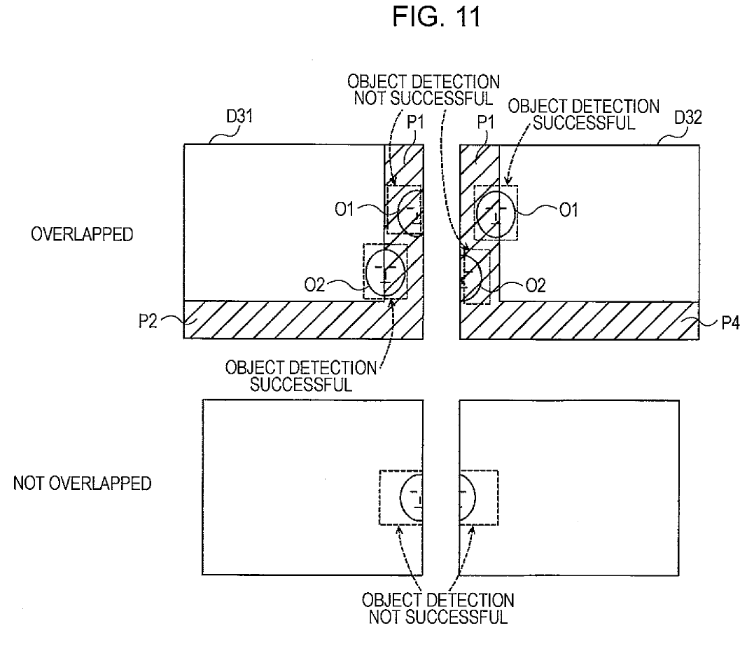

FIGS. 10 and 11 illustrate partitioned images. When an image is partitioned, an object such as a face image can be present on a partitioning line. An object straddling over two different pieces of partitioned image data cannot be detected. The image is thus partitioned so that one partitioned image has an overlapping portion with an adjacent partitioned image. As illustrated in FIG. 10, the image data D1 is partitioned into four partitioned image data units D31-D34. The partitioned image data units D31 and D32 have an overlapping portion P1, the partitioned image data units D31 and D33 have an overlapping portion P2, the partitioned image data units D33 and D34 have an overlapping portion P3, and the partitioned image data units D32 and D34 have an overlapping portion P4.

With the overlapping portions arranged in this way, an object O1 lacks a right portion in the partitioned image D31 while the right missing portion appears in the partitioned image D32 as illustrated in FIG. 11. An object O2 lacks a left portion in the partitioned image D32 while the missing left portion appears in the partitioned image D31. Even if an object present in the original image is not detected on one partitioned image in the object detection, the object is definitely detected from another adjacent partitioned image. Detection failure is thus controlled.

The width of the overlapping portion is preferably set to be equal to the maximum size of the detection window W0 in order to reliably detect an object on the partitioning line and minimize the size of the partitioned image data. Since an object having a size equal to or larger than the maximum size of the detection window W0 is detected from the contracted image data, an overlapping portion having a width larger than the maximum size is not necessary. If the width of the overlapping portion is set to be equal to the maximum size of the detection window W0, object detection is reliably performed and the size of the partitioned image data as an analysis target of the object detection is minimized.

In S215-S265, the area setter M3 sets the detection window W0 (detection outline) of each size within the partitioned image. The detection window W0 is a virtual outline defining a portion of the partitioned image. The object detector M4 acquires as the window image data WD the data of the partitioned image within the area defined by the detection window W0, and then performs the object detection process. As the detection window W1, the detection window W0 can take one of the various shapes. In the following discussion of S215-S265, operations identical to those of the contracted image analysis process are omitted.

In S215, counters nₛ, nₓ₀, n_{y0}, and n_{D} are reset. The x direction counter nₓ₀ provides an integer for shifting a center position P0 of the detection window W0 in the x axis direction. The y direction counter n_{y0} provides an integer for shifting the center position P0 of the detection window W0 in the y axis direction. The counter n_{D} counts analyzed partitioned image data units in integer. These counters are initialized to 1 at the resetting thereof. The size counter nₛ used for the contracted image data is also used here. The value at the completion of the contracted image analysis process is stored and the counter nₛ is reset to the stored value at the resetting performed in S215. This is intended to avoid duplicated detection of an object having the size detected in the detection window W1 set in the contracted image data. In the partitioned image data, the longitudinal direction of image data units D3-D6 is the x axis, and the short-side direction of the image data units D3-D6 is the y axis, and the origin of the x axis and the y axis is placed at the upper left corner of working image data.

In S220, the area setter M3 sets the detection window W1 having a size S centered on the center position P0 on the partitioned image.

In S225, the object detector M4 acquires and analyzes the window image data WD (the image data within the detection window W0) and detects a face image (a predetermined object) in accordance with the image feature quantity of the window image data WD. The window image data WD is different depending on the size of the detection window W0. In analysis, the window image data WD is resolution converted beforehand to a constant size. The calculation and analysis of the image feature quantity remain the same as those of the contracted image data D2 and the discussion thereof is omitted here.

In S230-S265, the detection window W0 is placed within the entire partitioned image with the size of the detection window W0 successively changed. The placement position of the detection window W0 is determined from the following equation (2):

P₀(x, y)=(dₓ₀nₓ₀, d_{y0}n_{y0}) (2)

dₓ₀=0.20×S₀

d_{y0}=0.04=S₀

where P0(x, y) represents a center position of the detection window W0, and dₓ₀ and d_{y0} represent a movement length representing unit travel distance (the number of pixels) of the center position P0 of the detection window W0 to each direction. By multiplying the movement length dₓ₀ and d_{y0} by the counts of the direction counters nₓ₀ and n_{y0} respectively, x and y coordinates of the center position P0 of the detection window W0 are calculated. Since the center position P0 calculated in equation (2) is set up anywhere in the entire partitioned image depending on the size of the detection window W0, the detection window W0 is set up covering the entire partitioned image. If the movement length d_{y0}<1, d_{y0}=1. The x direction counter by nₓ₀ takes an integer falling within a range of 1 to (the number of pixels of the partitioned image data in the x direction)/dₓ₀ and the y direction counter n_{y0} takes an integer falling within a range of 1 to (the number of pixels of the partitioned image data in the y direction)/d_{y0}. More specifically, the larger the detection window W0, the longer the unit travel distance of the detection window W0, and the smaller the detection window W0, the shorter the unit travel distance.

In S230, it is determined whether the detection window W0 has reached the right edge in the x axis direction. If the detection window W0 has not reached the right edge in the x axis direction, the x direction counter is incremented by 1 in S235 to shift the detection window W0 in the x axis direction by the unit travel distance dₓ₀. If the detection window W0 has reached the right edge the x axis direction, the x direction counter by nₓ₀ is reset to 1 in S240 to return the detection window W0 back to the left edge, and processing proceeds to S245.

In S245, it is determined whether the detection window W0 has reached the lower edge in the y axis direction. If the detection window W0 has not reached the lower edge the y axis direction, the y direction counter n_{y0} is incremented in S250 to shift the detection window W0 in the y axis direction by the unit travel distance d_{y0}. If the detection window W0 has reached the lower edge, the y direction counter n_{y0} is reset to 1 in S255 to return the detection window W0 to the upper edge, and processing proceeds to S260.

In S260, it is determined whether the detection window W0 has reached a predetermined size. The predetermined size is the one similar to the predetermined size in the contracted image data. At the predetermined size, the number of pixels of the window image data WD becomes lower than a predetermined number of pixels that can be analyzed in the object detection process. If the detection window W0 has reached the predetermined size, processing proceeds to S270. If the detection window W0 has not reached the predetermined size, the counter nₛ is incremented in S265 to contract the size S0 of the detection window W0 by unit quantity, and processing returns to S215.

The size counter nₛ is reset in S270. In S270, the counter nₛ is reset to the value at the completion of the contracted image analysis process in the same manner as in S215.

In S275, it is determined whether all partitioned image data units D31-D34 have been analyzed. More specifically, it is determined whether the counter n_{D} for the partitioned image data has reached a predetermined number. In accordance with the present embodiment, the image is partitioned into four, and the count n_{D} is an integer within a range of 1-4. When n_{D} reaches 5, all the partitioned image data units D31-D34 have been analyzed. If it is determined in S275 that n_{D} is 5, the partitioned image analysis process is completed. Processing then returns. If n_{D} is 4 or less, processing proceeds to S280 to increment the counter n_{D}, and then returns to S210. In S210, a partitioned image data unit not yet analyzed is generated and stored in the partitioned image analysis process, and S215 and subsequent steps are performed.

### Skin Complexion Adjustment and Printing Process

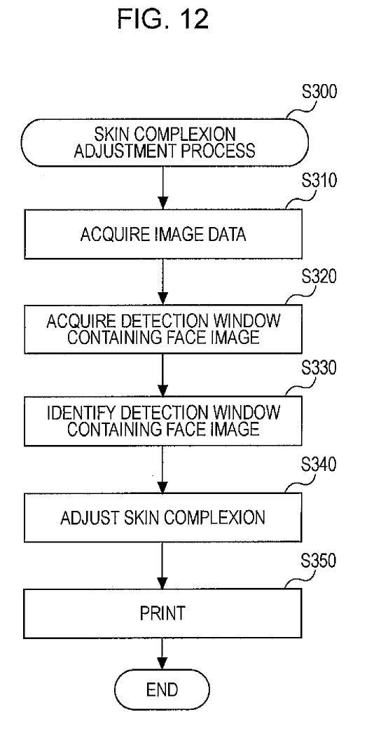

FIG. 12 illustrates a skin complexion adjustment process (image quality adjustment process) performed by the image corrector M5. In S310 of the image quality adjustment process, the completion of the contracted image analysis process and the partitioned image analysis process is detected, and the image data D1 is acquired as an adjustment target. In S320, the sizes S0 and S1 of the detection windows W0 and W1, determined as having a face image, and the positions P0 and P1 are read from the RAM 11. In S330, an area corresponding to the detection windows W0 and W1 determined as having a face image is identified in the image data D1. Since the sizes S0 and S1 of the detection windows W0 and W1 and the positions P0 and P1 have been retrieved from the RAM 11, the area corresponding to the detection windows is identified by converting the sizes S0 and S1 and the positions P0 and P1 into an image size of the image data D1.

In S340, the color of the pixels having skin complexion contained in the area identified in S330 is adjusted. The skin complexion pixels contained in the area identified in S330 are identified according to color values (such as red, green, and blue (RGB) values or hue, saturation, and value (HSV) values) of each pixel. The color values are corrected to preferred values. More specifically, the preferred values are stored beforehand on the HDD 14, and correction is performed so that the color values of the skin complexion come close to the preferred color values. Since the area containing the face image is identified by the detection windows W0 and W1, only the skin complexion pixels of the face image can corrected. If a plurality of detection windows containing face images are detected, the skin complexion adjustment may be performed for each of the windows. When the skin complexion adjustment is complete, the adjusted image data D1 is output to the printing unit 15 in S350. The printing unit 15 successively performs on the image data D1 a resolution conversion process, a color conversion process, a half-tone process, and a rasterize process, and prints an image responsive to the image quality adjusted image data D1.

### Modifications

In accordance with the above-described embodiments, the area setter M3 sets the detection window on the target image, and the object detector M4 analyzes the target image within the detection window and detects the predetermined object. The image data to be analyzed by the object detector M4 is either the contracted image data or the partitioned image data. If the detection window W0 is equal to or larger than the predetermined size, the contracted image data is a target of analysis. If the detection window W0 is smaller than the predetermined size, the partitioned image data is a target of analysis. When the analysis target is determined, the image contraction unit M1 contracts the image data to generate the contracted image data or the image partitioning unit M2 partitions the image data to generate the partitioned image data. Even if the work area size available for the expansion of the digital image data is not sufficient for the expansion of the digital image data, an appropriate image evaluation can be performed on the digital image data.

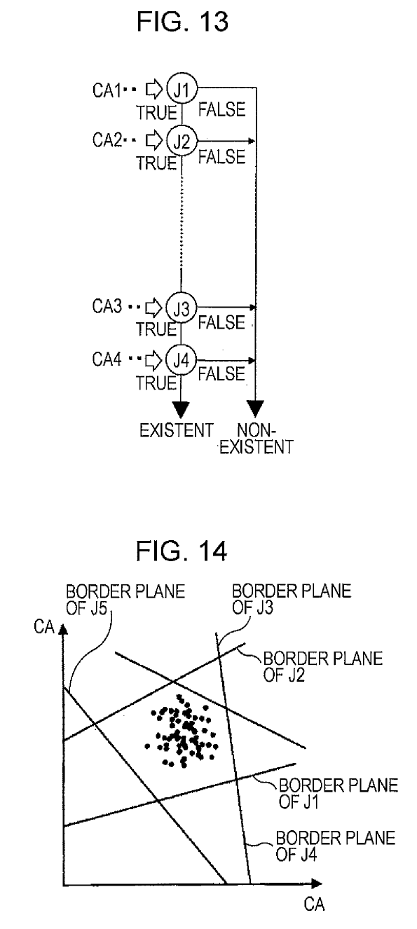

The face determination process is performed using the learning results of the above-described neural network. Alternatively, determinations means composed of a plurality of cascaded determiners J, J, . . . may be used. FIG. 13 illustrates a determination method of the face determination process. The determiners J, . . . , J receive respectively one or a plurality of feature quantities CA, . . . , CA of different types (for example, different filters), and output a true or false answer. The determination algorithm of the determiners J, . . . , J includes size comparison and threshold determination with respect to the feature quantities CA, . . . , CA, and each determiner has its own algorithm. The determiners J, . . . , J are respectively connected to the true answer output of their own preceding stage determiner. Only if the preceding determiner outputs the true answer, the subsequent determiner J performs the determination process thereof. If a false answer is output at any determiner J, a determination that no face image is present is output, and the face determination process is terminated. If all the determiners J, . . . , J output the true answer outputs, a determination that a face image is present is output, and the face determination process is completed.

FIG. 14 illustrates determination characteristics of a determination method in accordance with a modification of the embodiment. Feature quantity space defined by axes of feature quantities CA, . . . , CA used by the determiners J, . . . , J is shown. FIG. 14 illustrates in coordinates of the feature quantity space a plot of by combinations of feature quantities CA, . . . , CA obtained from the window image data WD finally determined as containing a face image. Since the window image data WD determined as containing a face image has some degree of feature quantity, the feature quantity is likely to have a distribution in an area in the feature quantity space. The determiners J, . . . , J generate border planes in the feature quantity space, and output a true answer if coordinates of the feature quantities CA, . . . , CA as a determination target are present within a space to which the distribution belongs. By cascading the determiners J, . . . , J, spaces outputting a true answer are gradually narrowed. With a plurality of border planes, a distribution having a complex shape is accurately determined.

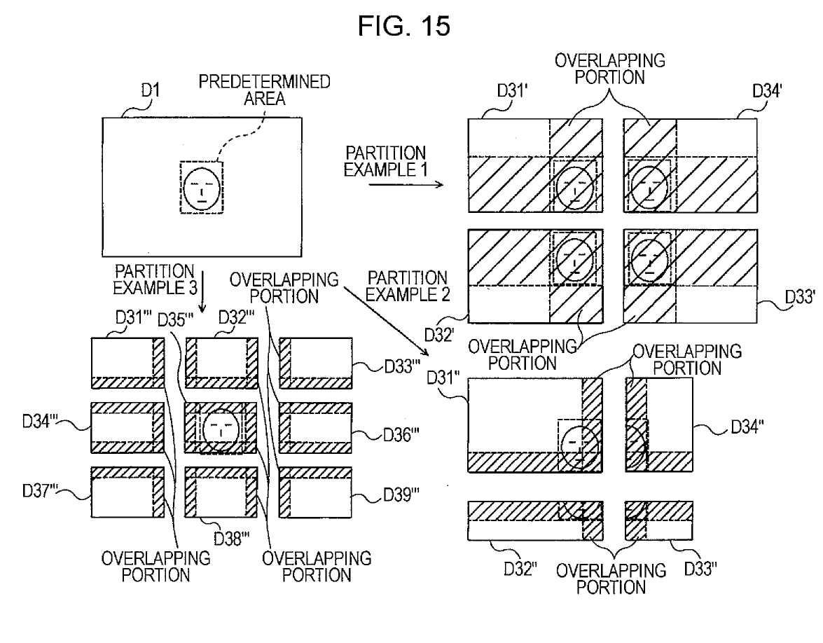

An important object is typically placed at an approximate center of the image data. As illustrated in FIG. 15, for example, a face image is placed at the approximate center of the image data. When the partitioned image data is generated, a predetermined area at the approximate center of the target image is preferably contained in the full form thereof as illustrated in the partition example of FIG. 15. In particular, a picture of a person is typically taken with the face of the person at the approximate center of the photograph. If the predetermined area at the approximate center is not partitioned to generate the partitioned image, the object is less likely to be divided and more likely to be detected. Referring to FIG. 15, the face image is placed at the center in both vertical and horizontal directions. The approximate center may also be understood as the center in a vertical direction or the center in the horizontal direction.

If the CPU in the printer 100 is a multi-core processor, the contracted image analysis process and the partitioned image analysis process may be performed in a parallel operation in the object detection process. In accordance with one embodiment of the invention, both the contracted image data and the partitioned image data are used. Even if the contracted and partitioned image data are concurrently expanded on the work area, the memory area used is still small. The parallel operation is easy, and fast processing is performed. If the contracted image data and the partitioned image data are concurrently expanded on the work area, a size for the contracted and partitioned image data is set for the capacity of the work area.

In the above-described embodiments, the size of the detection window is gradually reduced, and the size of the detection window is determined in the determination of whether to end the contracted image analysis process. The size of the detection window may be varied in a random fashion instead of gradual size reduction. If the size of the detection window is varied in a random fashion, one of the contracted image analysis process and the partitioned image analysis process may be performed after the determination of the size of the detection window with respect to the target image.

The invention is not limited to the embodiments described herein. Elements or combinations of elements of these embodiments may be exchanged, modified or combined with elements in the related art. Such changes and modifications fall within the scope of the invention.

What is claimed is:

1. An object detection method for detecting a predetermined object image from a target image, comprising:
contracting the target image to generate a contracted image;
partitioning the target image to generate a partitioned image; and
detecting the predetermined object image from the image using the image and a detection frame,
wherein the detection frame and the contracted image are used to detect the predetermined object image if the detection frame is equal to or larger than a predetermined size, and the detection frame and the partitioned image are used to detect the predetermined object image if the detection frame is smaller than the predetermined size.

2. The object detection method according to claim 1, wherein at least one of the images partitioned from one target image contains a predetermined area at an approximate center of the target image.

3. The object detection method according to claim 1, wherein the image partitioned from the target image has a portion overlapping an image partitioned from an adjacent area of the target image.

4. The object detection method according to claim 3, wherein the overlapping portion has a width approximately equal to a predetermined size of the detection frame.

5. The object detection method according to claim 1, wherein
the image used to detect the predetermined object image is represented by image data stored on a storage medium that stores data of a predetermined size or smaller size, and
each of the contracted image and the partitioned image is generated as data having the predetermined size or smaller size and then stored on the storage medium.

6. The object detection method according to claim 5, wherein
the object detection method is performed by a multi-core processor that performs parallel processing, and
the multi-core processor analyzes in the detecting of the predetermined object image the data of the contracted image and the data of the partitioned image in parallel processing.

7. An object detection apparatus that detects a predetermined object from a target image, comprising:
an image contractor that contracts the target image to generate a contracted image;
an image partitioner that partitions the target image to generate a partitioned image; and
a detector that detects the predetermined object image from an image using the image and a detection frame,
wherein the detector uses the detection frame and the contracted image if the detection frame is equal to or larger than a predetermined size, and uses the detection frame and the partitioned image if the detection frame is smaller than the predetermined size.

8. The object detection apparatus according to claim 7, further comprising a printing device that detects the predetermined object image from an image of input image data, image-quality adjusts the detected predetermined object image, and prints data of the image-quality adjusted image.

9. A computer program embodied on a computer-readable medium for causing a computer to detect a predetermined object image from a target image, the computer program causing the computer to perform the following steps:
contracting the target image to generate a contracted image;
partitioning the target image to generate a partitioned image; and
detecting the predetermined object image from the image using the image and a detection frame,
wherein the detection frame and the contracted image are used to detect the predetermined object image if the detection frame is equal to or larger than a predetermined size, and the detection frame and the partitioned image are used to detect the predetermined object image if the detection frame is smaller than the predetermined size

10. A recording medium storing a computer program for causing a computer to detect a predetermined object image from a target image, the computer program causing the computer to perform the following steps:
contracting the target image to generate a contracted image;
partitioning the target image to generate a partitioned image; and
detecting the predetermined object image from the image using the image and a detection frame,
wherein the detection frame and the contracted image are used to detect the predetermined object image if the detection frame is equal to or larger than a predetermined size, and the detection frame and the partitioned image are used to detect the predetermined object image if the detection frame is smaller than the predetermined size.
